(19) United States
(12) Patent Application Publication
(10) Pub. No.: US 2016/0041661 A1
(43) Pub. Date: Feb. 11, 2016

(54) SYSTEMS, METHODS AND COMPUTER READABLE MEDIUM RELATED TO SPORTS PERFORMANCE

(71) Applicant: Hotbox Sports LLC, Haworth, NJ (US)

(72) Inventor: Kevin Bertel, Haworth, NJ (US)

(21) Appl. No.: 14/920,813

(22) Filed: Oct. 22, 2015

Related U.S. Application Data
(63) Continuation-in-part of application No. 14/693,790, filed on Apr. 22, 2015.
(60) Provisional application No. 62/017,177, filed on Jun. 25, 2014.
(60) Provisional application No. 61/982,809, filed on Apr. 22, 2014.

(51) Int. Cl. G06F 3/048; A63F 13/46; A63F 13/235; A63F 13/795; A63F 13/533; A63F 13/828

(52) U.S. Cl. CPC G06F 3/048; A63F 13/533; A63F 13/828; A63F 13/235; A63F 13/795; A63F 13/46

(57) ABSTRACT

The present invention relates to systems, methods and computer readable medium for playing online games and more particularly to fantasy sports draft gaming. The game permits a user to select a lineup of players from a pool of available players. Preferably the players are placed in the pool based on the time that they will play during the day. Therefore in baseball, the user of the system will select a specific order of the players in the selected lineup to bat on the fantasy roster comprising a lead-off, second batter, third batter and a clean-up. The game will receive information about the player's performance at bat in the actual game and whether a given player has hit a single, double, triple or homerun. Thus the particular order in which the players are chosen to bat will ultimately determine the total score of points obtained by the fantasy sports user.

### CROSS REFERENCE TO RELATED APPLICATIONS

This application is a continuation-in-part of U.S. application Ser. No. 14/693,790 filed Apr. 22, 2015, which claims the benefit of U.S. Provisional Application No. 61/982,809 filed Apr. 22, 2014 and U.S. Provisional Application No. 62/017,177 filed Jun. 25, 2014. The content of each prior application is expressly incorporated herein by reference thereto.

### BACKGROUND OF THE INVENTION

1. Field of the Invention

The present invention specifically relates to systems and methods for playing online games, and more particularly to fantasy sports draft gaming and roster management.

2. Background

Fantasy sports leagues have become extremely popular in the U.S. It is estimated by the Fantasy Sports Trade Association (FSTA) that 32 million people at the age of twelve and above in the U.S. and Canada played fantasy sports in 2010. Participation has grown over 60 percent the past four years with 19 percent of males in the U.S. playing fantasy sports.

Thus, fantasy sports constitute an important niche market of sports betting and are estimated to have a $3-$4 Billion annual economic impact across the sports industry. As such, it is apparent that fantasy sports leagues represent a rapidly growing sports-related gaming industry.

In a fantasy sport league, people also referred to as users or owners draft real-life sports players for their fantasy rosters and thereby become a virtual general manager of a franchise sports team. The concept of picking players and running a contest based on their real-life statistics has been around since the 1960's, but with the ever evolving technology development in the field of computer servers, central networks and databases, the concept of sports draft gaming and betting especially in the area of fantasy sports has reached new heights in the 21^{st} century, as they can now be played across a network such as the Internet.

There are various ways that a fantasy league can account for its scoring to determine a winner based on the actual statistics. The first type referred to as “rotisserie” style is premised on each player's accumulative statistics for an entire season to all other teams in the league to figure out a particular user's scoring within the league. The real-life statistics of each player on each fantasy team are compiled over an entire real-life sporting season or a portion thereof. Then at the end of the accumulative fantasy period which can typically be an entire season of the actual sport, the statistics for the entire fantasy team are totaled and compared to the accumulative statistics of all of the other fantasy teams in a particular fantasy league.

Generally multiple statistical categories are used in this comparison. As an example, in baseball a “5×5” rotisserie league may use batting average, steals, homeruns, runs batted in, earned run average; saves, walks plus hits per innings pitched, strikeouts, wins, losses and walks plus hits per inning pitched for the pitchers. The fantasy team with the best accumulative statistics typically wins the fantasy season. Collectively, there would be ten categories that a team manager can earn points in and each are assigned a point in this form. The total accumulated points that each fantasy team attains in each statistical category would be added together for the entire season in order to arrive at their total score. Because of the great number of games in a baseball season together with the varying numbers of games played in a given week, the rotisserie format is well suited for fantasy baseball league participants, as it minimizes the time commitment of the participating roster managers.

Notwithstanding its simplistic way of accounting for the statistics in order to declare a winner, there is however an apparent problem with the rotisserie system. One potential issue is the fact that it is conceivable for the accumulative statistics of one fantasy team to reach an extent during the fantasy season, that no matter how well the players on the other fantasy teams perform throughout the rest of the fantasy season, they are not able to catch up with the leader. It goes without saying that typically teams that fall behind in the rankings early in a season are unable to make up the lost ground, and there is wide variation between the leading fantasy team and the other fantasy teams. Thus, there is a possibility that player interest may drop significantly, and in turn, fantasy leagues witness a drop-off in participation.

A second type of format is generally known as the “head-to-head” style. The fantasy season is broken up into discrete fantasy games such as weekly totals. In other words, the fantasy games are generally scheduled over regular intervals, such as a week of an actual season of the particular sport for the duration of the season. In professional baseball like Major League Baseball (MLB), the regular interval may consist of a one week period including all games between Monday and the following Sunday. In head-to-head form of fantasy sports, generally a first fantasy team plays and competes directly with a second fantasy team. This is in contrast to the comparison of the entire league throughout the whole season in the rotisserie style. The scores from the first and second fantasy teams are compared, and subsequently a winner is declared based on the highest statistics of those two teams regardless of the scores of other teams in the league. In a typical head-to-head format, the head-to-head match ups change in each interval. For example in a four team league, team 1 plays team 2 and team 3 plays team 4.

The scores of the teams playing one another, for example 1 and 2 are compared to determine a winner for the interval such as a week. The following week team 1 may play team 3 head-to-head. The statistics of each player on each fantasy team for that interval are totaled. The accumulated statistics for each player on each fantasy team are then totaled to produce a fantasy team score, and the team's scores are compared to the team scores of the competing fantasy team. The fantasy team with the best team scores is declared the winner of that particular fantasy head-to-head game of that interval.

However one potential issue with the head-to-head format is that the statistics of some or all of the players on the first fantasy team might be too low compared to the statistics of the players on a second competing fantasy team, because the players on the first fantasy team may not play as many real-life games during that time interval as the second team. This may be the result of an injury which would result in that the fantasy team would have one less player to accumulate points from. Thus, the first fantasy team may lose a particular fantasy game even though the players on the first fantasy team are otherwise better performing players over the course of an entire season than those on the opposing fantasy team, simply because the competing team's players had a more intensive real-life schedule followed by a larger number of real-life games due to prevention of injury over a particular time-interval. The head-to-head format creates artificial delineations in scheduling, and therefore, it is often not an accurate and true measure of a fantasy teams overall value.

Notwithstanding the fact, that the head-to-head format provides fantasy players with frequent results for each defined time interval, the head-to-head format has a tendency to lose the interest of a fantasy team owner because of the inherent inequalities that tend to exist using artificial fantasy schedules and match ups, which may result in a fantasy team rapidly falling out of contention. Therefore both the head-to-head and rotisserie formats suffer from an obvious inability to keep fantasy players interest while the fantasy sports activity is ongoing. Dissipated continuing attention in the rotisserie format is largely attributable to the large number of games that the fantasy team owner must monitor over the course of an entire sport season and throughout the period over which the players statistics are accumulated, whereas in the head-to-head format, lost interest is typically due to the artificial boundaries of the schedule, which can cause variations in fantasy player performance despite solid performance during the real athletic event.

In view of the above given the weaknesses inherent in the existing prior art that utilizes the head-to-head and rotisserie fantasy sports formats, there is an unmet need for fantasy sports systems and methods of use thereof, that essentially provide much quicker results to the fantasy sports user with the ultimate end-goal of keeping the ongoing interest of fantasy team owners.

### SUMMARY OF THE INVENTION

The present invention advantageously provides systems and methods thereof to fully maintain the ongoing interest of fantasy participants in their fantasy teams, which has been lacking in the prior art. The present invention also advantageously provides an automated system and generally evaluating the performance of fantasy teams real-time as the games are being played.

More specifically, the present invention relates to systems and methods of providing fantasy sports to a user, which does not span a lengthy time-period such as a full regular season of the actual sports event.

The various embodiments of the game are applicable to real-life sport events such as but not limited to baseball and cricket, which thereby permit a fantasy sports user to select a lineup of players from a pool of available players from a plurality of teams.

Preferably the players are placed in the pool based on the time that they will be playing during a given day. Therefore in baseball for example, the user of the system will select a specific order of the players in the selected lineup to bat on the fantasy roster which will comprise a lead-off, second batter third batter, and a clean-up. The game will receive information about the player's performance at bat in the actual game, and whether the given player has hit a single, double, triple or homerun. Thus it follows that the particular order in which the players are chosen to bat will matter significantly and will ultimately influence the total score of points reflecting the total runs that a fantasy team owner thereby obtains.

The present invention is further directed to a system for playing a fantasy sport. A processing system is configured and adapted to communicate with a computer, wherein the processing system is arranged to accept input of a real-life sports events such as but not limited to baseball and cricket in order to demonstrate the performance of the fantasy sports team by determining the total score of points as described hereinabove reflecting the total number of runs performed by the selected players that a fantasy sports team owner achieves.

The present invention is in addition directed to an article of manufacture including a computer readable medium and a data structure adapted and configured to route signals.

The data structure includes a computer readable system for playing a fantasy sport including a processing system configured and adapted to communicate with a computer. The processing system is arranged to accept input of a real-life sport events such as but not limited to baseball and cricket, wherein a user forms a fantasy roster team selecting a lineup of players from a pool of plurality of players. Thus, in baseball for example, the user of the system will create a specific order of the players in the selected lineup, which will bat on the fantasy roster and the user will select the order of a lead-off, second batter, third batter, and a clean-up. The game will receive information about the player's performance at bat in the actual game, and whether the given player has hit a single, double, triple or home run.

In accordance with principles of the present invention, innovative systems such a game system can be provided. The game system can comprise a computer system comprising one or more computers including transient and non-transient memory and including network connections and equipment, that are together configured to provide features comprising: an initial interactive interface that displays a selectable option to enter a fantasy sports game; a database comprising data fields and data values representative of real life sports teams, real life upcoming schedule of the real life teams, real life players that are currently on the active rosters of the real life sports teams, status of real life players in connection with the upcoming games, and data representing statistical performance of the real life players in regularly scheduled games of the real life sports teams; an interactive new team interface implemented by the computer system in which individual users of the game system are provided with a team creation option that when selected provides the opportunity to make selections to complete a team submission; an active real life player engine; game data input port; a team performance processor, and an action interface.

The active real life player engine is configured on the computer system. The active real life player engine receives an input from an individual user indicating that the user has selected to submit a fantasy sports team into system and also receives information about the current time, in response to receiving the input, processing the data stored in the database and a predetermined near term time window and applying the near term time window to the data values in the database wherein the computer system generates an output identifying which real life players in the database are scheduled to play during the upcoming near term time window and identifies which real life games the identified players are scheduled to play in, and further wherein the computer system only identifies a subset of real life players from players that play in a corresponding real life league or sport so as to divide a season of scheduled games into smaller time windows comprising multiple upcoming games or portions of games but less than a full or remaining season.

The interactive team selection interface, similar to other describe components or features, is configured on the computer system. The interactive team selection interface receives the output from the active real life player engine, and retrieves and displays data from the database associated with a plurality of the identified real life players, specifies a number of team player slots that form a team submission for the fantasy sports game of the user, and receives and stores input selections in response to the user selecting different ones of the real life players identified by the active real life player engine and the user also selecting a particular sequence in which the selected real life players are placed in a sequential performance lineup on the individual user's fantasy sports team as part of the individual user's fantasy team in the fantasy sports game, wherein the sequence is asynchronous in comparison to an actual time sequence in which the selected real life players play in their corresponding real life games,

The game data input port receives and stores performance statistical data values generated from the actual play of real life player and representative of real life athletic achievement of real life players in the real life scheduled games.

The team performance processor (the processor in this context is implemented on the computer system) that receives team information identifying the real life players selected by the individual user to be on the user's team, receives performance statistical data values from the game data input port, associates the performance statistical data values with the real life players on the user created team, compares individual performance values between each real life player on the user created fantasy sports team and a subsequent one of the individual life players on the user created fantasy sports team in accordance with the user-selected sequence, based on the comparing, determining whether one or more in-fantasy sports game performance inter-relationships between the individual performance values of the real life players of the user created team based on the player performance lineup sequence of play selected by the user qualifies to meet at least one in-game team performance advancement characteristic, generates an in-game or final fantasy sports score for the user-created fantasy sports team by modifying the performance value of the real life players on the user created team with an in-fantasy sports game performance inter-relationship value associated with the at least one in-game team performance advancement characteristic to produce a score value that incorporates an enhanced performance relationship arising from the one or more in-fantasy sports game performance inter-relationships, and stores and transmits the score value as part of displaying the score value to the user.

The action interface applies the score value to outcome criteria and based on the applying generates an outcome output value indicative of whether the user has qualified to be a recipient of a particular operation by the game system.

In some embodiments, the game system is a fantasy baseball game system wherein the system is configured to determine whether one or more in-fantasy sports game performance inter-relationships comprises a first performance value for a first real life fantasy player on the user created fantasy team has a characteristic sufficient to advance a second performance value for a second real life player on the user created fantasy team, wherein the second real life player precedes the first real life fantasy player on the user selected lineup sequence.

In some embodiments, the game system comprises an fantasy point system that associates a particular fantasy point with different performance statistic values is a fantasy football game system wherein the system is configured to determine whether one or more in-fantasy sports game performance inter-relationships comprises a first real life player and second real life player that are designated for different downs on the user created fantasy sports team together have sufficient yards to have a first down.

In some embodiments, the game system comprises a fantasy point system implemented as part of the computer that system that assigns fantasy points to different events or performance values in the real life sport.

In some embodiments, the game system identifies real life players for selections as party of a team submission using only a portion of upcoming games.

In accordance with the principles of the invention, a fantasy sports system can be provided. The fantasy sports system comprising a computer that is adapted and configured to implement a fantasy sports game, wherein the game is configured and adapted to allow a fantasy sports user to select a fantasy sports team from a pool of plurality of players having a game in an upcoming near term window, and wherein the computer further determines an order of each of the selected players on the fantasy sports team and the computer receives information about the selected players performance in the game, whereby a total score of points is calculated and issued to the fantasy sports user, wherein the order in which the players are selected to play influences the total score of points.

The fantasy sports system can implement fantasy sports that is major league baseball.

The fantasy sports system can be one wherein the total score of points is an accumulated measure of completed runs performed by each of the selected players having games in the upcoming near term window.

The fantasy sports system can implemented wherein the selected players comprise a lead-off, second batter, third batter and a clean-up.

The fantasy sports system wherein each of the selected players in the lineup bat once in the fantasy sports system.

The fantasy sports system can configured wherein a prize having a predetermined amount is awarded to the fantasy sports user wherein the amount correlates positively with the total score of points thereby achieved by the fantasy sports user.

The fantasy sports system can further comprise a processing system adapted to communicate with a plurality of computers, wherein the processing system is arranged to accept input of the fantasy sports game, such that the processing system calculates the total score of points.

The fantasy sports system is implemented wherein the computer is further connected to a server such that the user is able to play the fantasy sports game over the Internet.

In some embodiments, the fantasy sports system is implemented for cricket.

In accordance with principles of the present invention, a method of playing fantasy sports on a computer is provided. The method comprises selecting a fantasy sports team from a pool of plurality of players having a game in an upcoming near term window; determining an order, in which each of the selected players on the fantasy sports team plays; and receiving information about the selected players performance in the game, whereby a total score of points is calculated and issued to a fantasy sports user, wherein the order in which the players are selected to play influences the total score of points, such that the play of one player will increase the total score of points if the player is placed in a certain spot on the fantasy sports team.

In some embodiments, the fantasy sports is selected from the group consisting of major league baseball and cricket. In some embodiments, the total score of points is an accumulated measure of completed runs performed by each of the selected players having games in the near term window.

In some embodiments, the method further comprising selecting a lead-off, second batter, third batter and a clean-up. This is a selection of lineup for submission as the user's team before the fantasy game starts. In some embodiments, each of the selected players bats once.

In some embodiments, the method comprises playing the fantasy sports on a computer, in which the computer is connected to a server, such that the fantasy sports user is able to play the fantasy sports game over the Internet.

In accordance with principles of the present invention, an article of manufacture can be provided. The article of manufacture comprises a computer readable medium; and

a data structure stored thereon configured and adapted to route signals wherein the data structure comprises a computer readable system for playing fantasy sports having a processing system configured and adapted to communicate with a plurality of computers wherein the processing system is configured and adapted to accept input of fantasy sports information including a specific order of selected players from a pool having a plurality of players having a game in an upcoming near term window, whereby the processing system calculates a total score of points for a fantasy sports team. The fantasy sports can be selected from the group consisting of major league baseball and cricket. In some embodiments, the total score of points is an accumulated measure of completed runs performed by each of the selected players. The specific order of selected players may comprise a lead-off, second batter, third batter and a clean-up.

In some embodiments, a gaming machine is implemented that is configured to operate the fantasy game for users or operate a portion thereof. A system involving a gaming machine and external device can be implemented that is configured to provide the fantasy game to users. The gaming machine may be connected over a network to other external devices such as for the purpose of receiving statistics or performing central processing. The gaming machine can perform various operations including for example a particular operation such as a payment to the user if the team selected by the user in the current game meets a winning criteria.

Embodiments of the present invention are directed to provide gaming systems that provide wagering that allow users to win or lose wagers based on the outcome of their selected team.

It will be apparent to a person having skills in the art to which this invention pertains, that the particular order in which the players are chosen to bat will ultimately influence the total score of points reflecting the total runs that a fantasy sports team owner attains.

### BRIEF DESCRIPTION OF DRAWINGS

FIG. 1 is a representative view of a single lineup/ticket in accordance with one embodiment of the present invention.

FIG. 2A-2C are representative views of multiple lineups/tickets in accordance with one embodiment of the present invention.

FIG. 3A-3B are representative views in accordance with one embodiment of the present invention and they demonstrate how a fantasy sports user first selects and thereafter verifies the fantasy sports team from a pool of plurality of players who have a game coming up in a near term window respectively in FIG. 3A and FIG. 3B.

FIG. 4 is a representative illustration of a block diagram with various computer system components for use with an exemplary implementation of a fantasy sports system in accordance with one embodiment of the present invention.

FIG. 5 shows a communication system 30 of the present invention for use with the computer system of FIG. 4 in accordance with one embodiment of the present invention.

FIG. 6 illustrates the method and steps of the present invention in accordance with one embodiment of the present invention. As an illustrative example, baseball is used.

FIG. 7 is a representative illustration of a block diagram with various computer system components for use with an exemplary implementation of a fantasy sports system in accordance with one embodiment of the present invention.

FIG. 8 depicts an illustrative gaming machine on which the fantasy game of the present invention is implemented.

FIG. 9 depicts various illustrative components of the gaming machine in FIG. 8.

### DETAILED DESCRIPTION OF THE INVENTIVE EMBODIMENTS

The following definitions set forth the parameters of the current invention.

As used herein, the term “homeplate” refers to the final base that a player must touch in order to score a run.

As used herein, the term “homerun” refers to an event where the ball is hit in such a way that the batter is able to circle the bases and reach home safely in one play.

As used herein, the term “grand slam” refers to a homerun hit with all three bases occupied by base runners thereby scoring four runs in total.

As used herein, the term “lead-off” refers to the first hitter in a lineup.

As used herein, the term “clean-up” refers to the last batter in a lineup.

As used herein, the term “strikeout” refers to when a batter accumulates three strikes during a time at bat which means that the batter is out.

As used herein, the term “sacrifice fly” refers to the advancement of all base runners with one base.

As used herein, the term “hit-by-pitch” refers to a batter or his equipment being hit by a pitch from the pitcher which encompasses an advancement of all base runners with one base.

As used herein, the term “wild pitch” refers to a charge against a pitcher when his pitch is too high, too short, or too wide of home plate for the catcher to control with effort.

As used herein, the term “steal” refers to the advancement during the delivery of a pitch without the aid of a base hit.

As used herein, the term “fielder's choice” refers to a fielder fielding a fair ball and choosing to try to put out another base runner, thereby allowing the batter-runner to safely reach first base.

As used herein, the term “double play” refers to a team or a fielder which is the act of making two outs during the same continuous playing action

As used herein, the term “triple play” refers to an act of making three outs during the same continuous play.

As used herein, the term “user” refers to virtual the manager who selects the players to be in each fantasy league roster.

As used herein, the term “near term window” refers to a period of time wherein all players in the fantasy sports line-up will have only one at bat in that time window.

As used herein, the term “fantasy league” refers to a league that may include at least two or more teams and rosters hand-picked by each user competing against each other.

As used herein, the term “statistics” is defined as encompassing any identifiable, measurable recorded value accrued by a given player in the player's actual sport. It will be apparent to a person having skill in the art that each individual sport has its own preferred and commonly denoted statistics. Thus in baseball for example, commonly used statistics may for example be but not limited to batting average, steals, homeruns, runs batted in, earned run average, saves, walks plus hits per innings pitched, strikeouts, wins, losses and walks+hits per inning pitched for the pitchers.

As used herein, the term “correlation” refers to any dependent relationship between two random variables. Thus “positive correlation” would be the increase of one variable when the second variable increases.

As used herein, the term “rotisserie” refers to a format where the statistics are accumulated for an entire season.

As used herein, the term “head-to-head” implies a format where a user's statistics for one week are compared to a single other team for the same week, and at the end of the week, the teams get some number of wins and losses based on that comparison.

As used herein, the term “lineup/ticket” refers to the selected fantasy sports roster in which each player will only bat once in a given order as determined by the user.

As used herein, the term “Random Access Memory (RAM)” refers to a computer data storage. A RAM device allows data items to be read and written in the same amount of time regardless of the order in which data items are accessed.

As used herein, the term “Graphical User Interface (GUI)” refers to a human-computer interface that uses windows, icons and menus and which can be manipulated by a mouse.

As used herein the term “database” refers to a medium that collects the information of data that is organized such that it can easily be accessed, managed and updated. The data are typically organized to model relevant aspects of reality in a way that supports processes requiring this information.

As used herein, the term “server” refers to a system that responds to requests across a computer network to provide and to help to provide a network service.

As used herein, the term “software” refers to the programs and other operating information used by a computer.

As used herein, the term “hardware” refers the collection of physical elements that comprise a computer system.

As used herein, the term “network” refers a system that allows computers to exchange data. In computer networks, networked computing devices pass data to each other along data connections. The connections and network links between nodes are established using either cable media or wireless media. An example of a computer network is the Internet.

As used herein, the term “display interface” refers to the visual part of computer application or operating system through which a user interacts with a computer or a software. It determines how commands are given to the computer or the program and how information is displayed on the screen.

As used herein, the term “modem” refers to a device that modulates an analog carrier signal to encode digital information and demodulates the signal to decode the transmitted information. The aim is to produce a signal that can be transmitted easily and decoded to reproduce the original digital data.

As used herein, the term “chip” refers to a piece of silicon with an electronic circuit embedded in it.

As used herein, the term “processor” refers to a small chip that resides in computers and other electronic devices where its basic job is to receive input and provide the appropriate output.

As used herein, the term “application specific integrated circuits (ASIC)” refers to a chip that is custom designed for a specific application rather than a general-purpose chip such as a microprocessor.

As used herein, the term, the terms “computer program medium” and “computer usable medium” are used to refer generally to media such as a removable storage drive, a hard disk installed in hard disk drive and signals.

As used herein, the term “router” refers to a network device that forwards information from one network to another.

As used herein, the term “wireless” refers to the transfer of information between two or more points that are not connected by an electrical conductor.

As used herein, the term “terminal” refers to an electronic or electromechanical hardware device that is used for entering data into, and displaying data from a computer or a computing system.

As used herein, the term “transient memory” refers to a memory that temporarily holds data while it is being used whereas non transient does not include the restriction to a temporary time-interval. Non-transient memory is generally understood by those of ordinary skill in the art and for example, it can include, non-volatile storage such as a hard drive. Non-transient memory, as is well understood, can store program instructions that are executable by a computer and when executed implement software application for users. The program instructions carry out electronic computer process steps on the computer or devices that they are implemented on.

As used herein, the term “accessor” refers to a method that fetches private data that is stored within an object. Thus an “accessor” provides the means by which to obtain the state of an object from other program parts. An “accessor” is used interchangeably herein as the “user”.

As used herein, the term “mobile app” refers to a computer program designed to be run on mobile devices.

As used herein, the term “asynchronous sequence” refers to the fact that compared to an actual time sequence, in which the selected real life players play in their corresponding real life games, as an example, the selected players on the fantasy sports roster may start with the lead-of batting first at 4 pm, followed by the first batter batting at 12 pm, and then by the third batter at 1 pm ending with the clean-up at 2 pm. Thus “asynchronous sequence” encompasses inherent time-differences all depending on in which order a given player has been chosen to bat on the fantasy sports roster or lineup, as compared to the time that the corresponding real life sports event actually takes place.

As used herein, the term “in-fantasy sports game performance inter-relationship” refers to the interrelationship between performance of the players within the fantasy sports game and not in the real life sports event.

The different inventive embodiments of the instant invention will now be discussed in more detail referring generally to the Figures that accompany the present application and thus various embodiments are disclosed herein.

However it should be clearly understood that the disclosed embodiments are merely for illustrative purposes of the disclosure that can be embodied in various multiple forms.

Thus, specific structural and functional details disclosed in the specification are not to be interpreted limiting whatsoever, but merely as representative basis for teaching the person having ordinary skill in the art to which the invention belongs how to employ the disclosed embodiments.

The present invention is directed to a fantasy sports systems, gaming machines, methods and computer readable medium of playing fantasy sports, which conveniently allows the fantasy roster owner to focus the owner's attention to time-periods that are considerably shorter than the regular season of the real-sports events, such that the loss of interest typically associated with rotisserie and head-to-head format fantasy sports is advantageously overcome.

Preferably, the present invention includes a computer or other suitable processing system with application software and a communication network, such as the Internet. The present invention in one embodiment provides a graphical user interface (GUI) for the entry of data, such as the players selected for each fantasy team, as well as the real-life games of each player corresponding to a particular fantasy sports game. The GUI also presents information in a graphical manner to show the statistics of fantasy teams and the players on those teams. Statistics are calculated, input, or provided by a database either manually or preferably automatically and/or electronically by computer or similar processing device. Electronically includes but is not limited to a computer, Internet, or other suitable electronic processing unit.

For the purposes of the illustrative aspects of the invention, a real-life sports event typically includes sports events such as but not limited to Major League Baseball (MLB) and cricket.

Thus the whole premise with different aspects and embodiments of the present invention is for the fantasy team roster user to select a lineup/ticket of plurality of players from a pool of available players from a plurality of teams that will be playing during a given day based solely on the time that the players will be playing. This allows the fantasy sports game a time window for the performance of the lineup/ticket. In some embodiments, a given fantasy roster user may select only a single lineup/ticket, whereas in other embodiments multiple lineups/tickets may advantageously be selected. Thus when the fantasy sports is MLB for example, the user is given the choice to select four players, which will comprise a lead-off, second batter, third batter and a clean-up from the pool of plurality of available players as described hereinabove in the near term window, and further also determine the order in which each player will bat on the fantasy roster.

As such, the near term window can be any period of time, wherein all selected players in the fantasy sports line-up will bat at least once in that time-window, and only their first appearance will count on the fantasy roster once the lineup/ticket has been submitted by the user. The fantasy sports game will receive information regarding a given player's performance, when that player bats in the actual game, and whether that player's actual performance results in a single, double, triple or homerun, which will ultimately influence the accumulated total amount of points thereby achieved by a fantasy sports user.

Therefore without being limited, as a way of example, the whole hall-mark of the game is to strategically determine the order of the players in which they will bat, which will solely determine the outcome of the game, as the total accumulated points thereby achieved, will correlate with the runs scored in the fantasy sports game as the scoring component.

Thus it should be understood that what the batter does at the home plate will affect the runners, and as such, when a player advances all four bases, that specific player scores a run for the fantasy sports team.

To illustrate this in more specific detail, if a given selected player who is batting first in the lineup/ticket, and that player hits a homerun and the following three players in the lineup/ticket hit singles, the fantasy sports user will only accrue points for the single run, which is scored by the homerun. However in the event, where the fantasy sports user had placed the player who hit the homerun as the last player in the lineup/ticket instead of batting first, there would be four runs in total, as the three singles would have been converted to runs by the last batter who hit a homerun. Accordingly, if the homerun was achieved in the grand slam in the actual game, the scoring value in the fantasy sports game would be the homerun and any runs that result from the fact that, at least the other three first players who hit prior to the last player were already located on a base. Thus in this particular instance, the fantasy sports player would accrue a total score of four points. Therefore to further emphasize, the runners are not affected in the chronological order that they actually bat in the real-life sports event, but solely in the batting order that the fantasy sports owner selects them to bat on the fantasy sports roster.

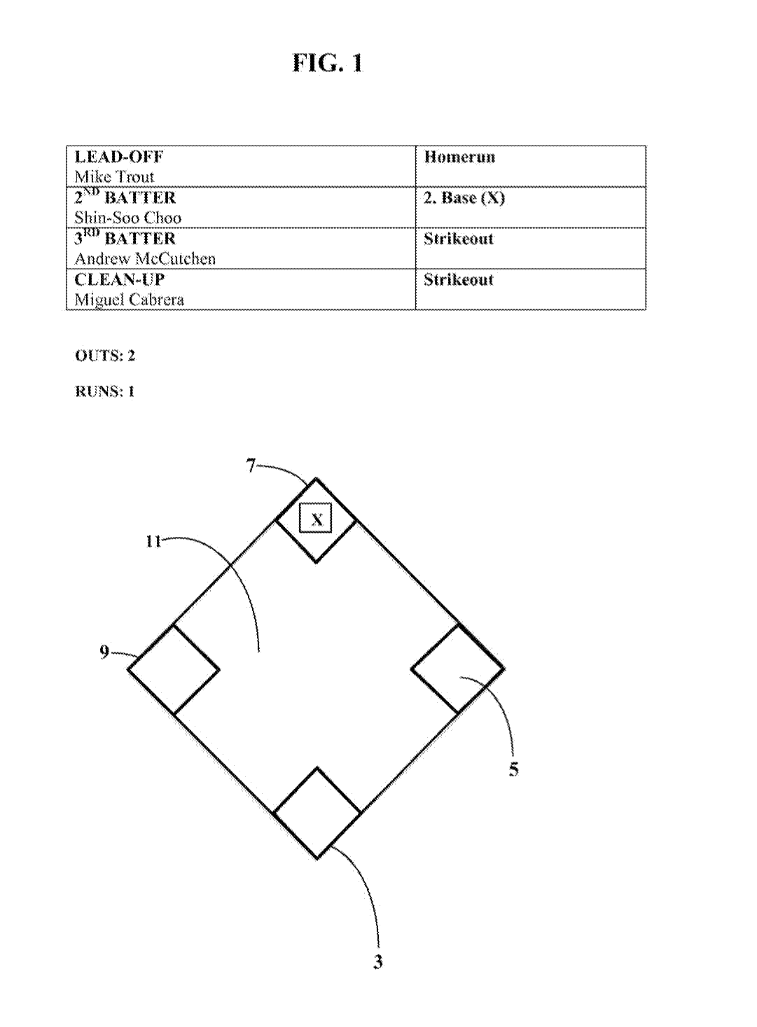

This embodiment is further exemplified in FIG. 1 in more detail, wherein 3, 5, 7 and 9 represent the homeplate, first base, second base and third base respectively and 11 is a representation of a schematic view of a baseball field. FIG. 1 further shows a fantasy sports user who has a single lineup/ticket consisting of the players Mike Trout chosen as the lead-off, Shin-Soo Choo selected as the second batter, Andrew McCutchen picked as the third batter and finally Miguel Cabrera chosen as the clean-up. Further what is shown in FIG. 1 is the fact that the lead-off Mike Trout has hit a homerun, and the second batter Shin-Soo Choo is on the second base (X) and the third batter Andrew McCutchen and the clean-up Miguel Cabrera both have a strikeout. In this specific example, the fantasy sports user would accrue one point in total from the homerun achieved by the lead-off Mike Trout. However if Mike Trout was to be placed as the second batter instead of Shin-Soo Choo, the fantasy sports user would then accrue a total of 2 points instead, as the homerun would have converted the second base to a run.

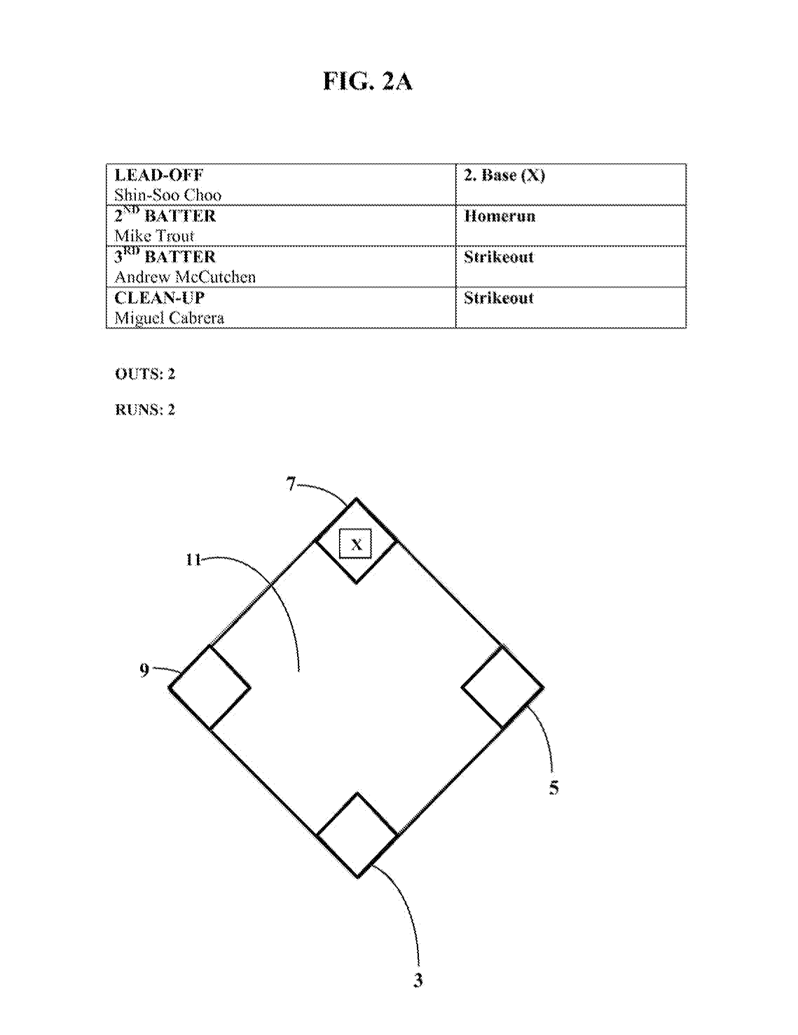

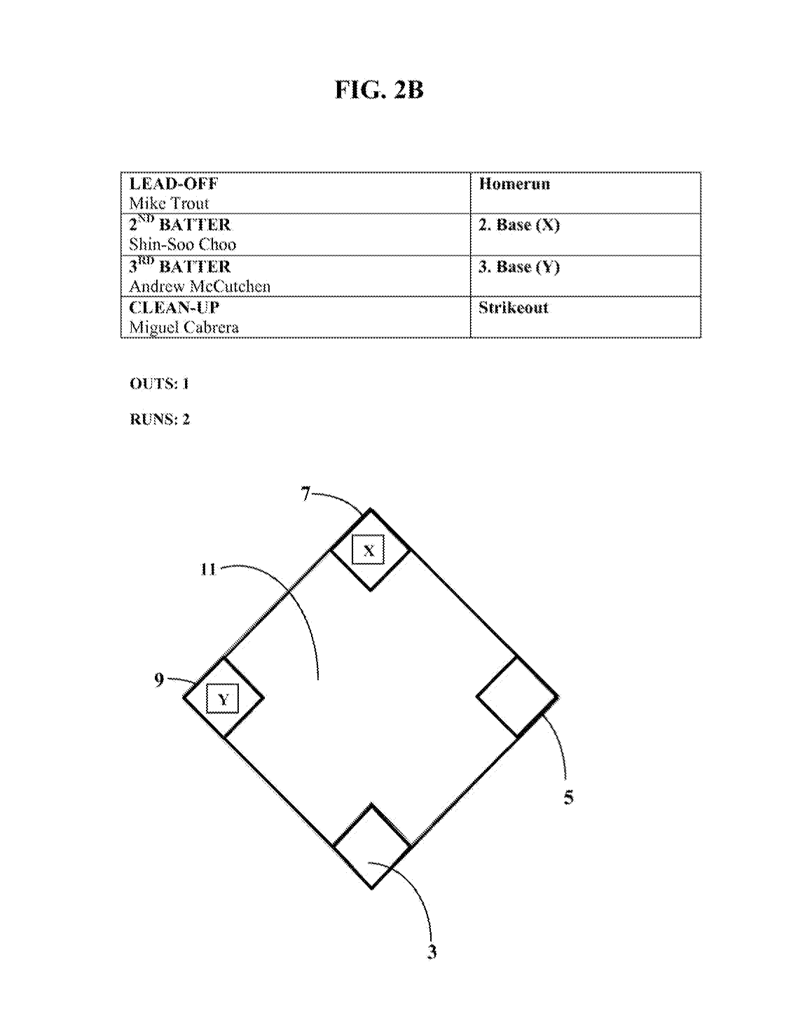

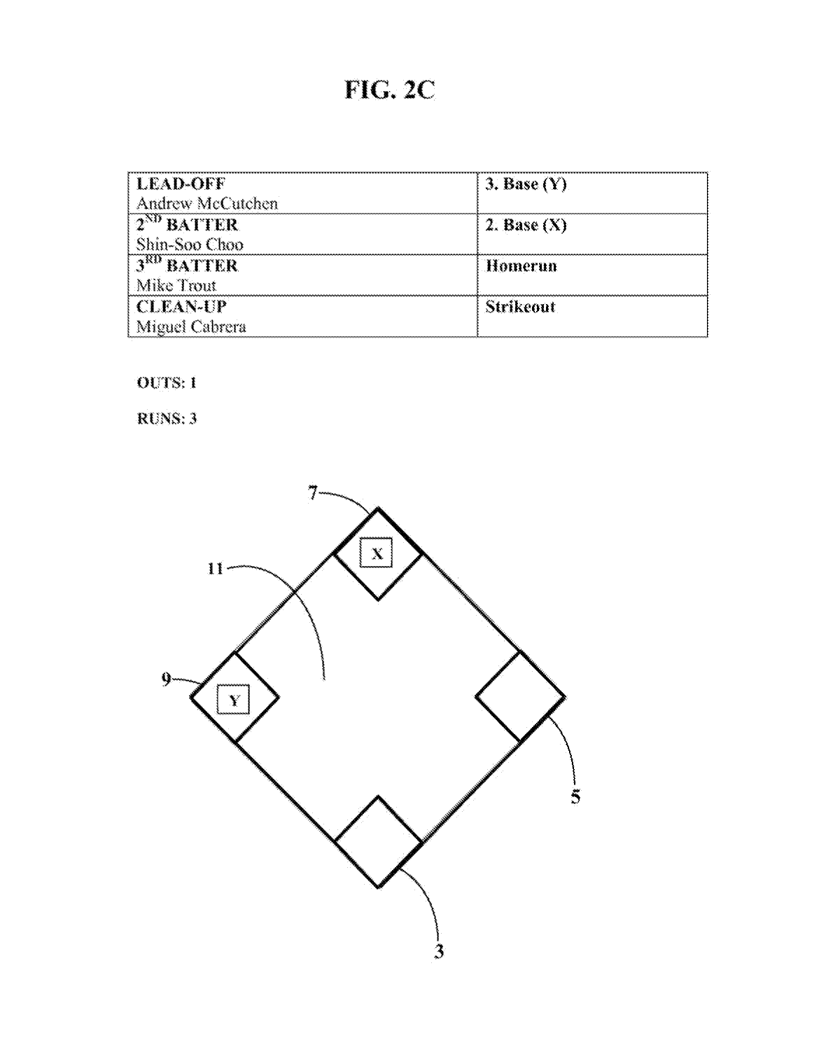

In another embodiment of the present invention, FIG. 2A-2C all demonstrate cases where multiple lineups/tickets have been selected, wherein 3, 5, 7 and 9 once again represent the homeplate, first base, second base and third base respectively and 11 is a representation of a schematic view of a baseball field. FIG. 2A sets forth a lineup/ticket, where as described in FIG. 1, the order of the former lead-off Mike Trout has been changed to a second batter, whereas the second batter in FIG. 1 Shin-Soo Choo is now the lead-off instead. In this particular exemplification, as mentioned hereinabove, a total of 2 points are obtained as the homerun further results in the conversion of the second base (X) to a run.

Yet another lineup/ticket is demonstrated in FIG. 2B wherein the fantasy sports user has chosen the same order of batters as in FIG. 1, and the fact that Andrew McCutchen who has reached the third base (Y) alters the total accumulated score to 2 points obtained through the homerun by Mike Trout and Andrew McCutchen's third base hit, which also ensures that Shin-Soo Choo's second base presence is turned into a run. Yet still another lineup/ticket is shown in FIG. 2C, where this time, Mike Trout who was the lead-off in FIG. 1 has been chosen as the third batter on this lineup/ticket and Andrew McCutchen is now the first batter instead. In this example, a total score of three points are accumulated as the homerun hit by Mike Trout also drives home the lead-off and the second batter, who are situated on the third (Y) and second base (X) respectively.

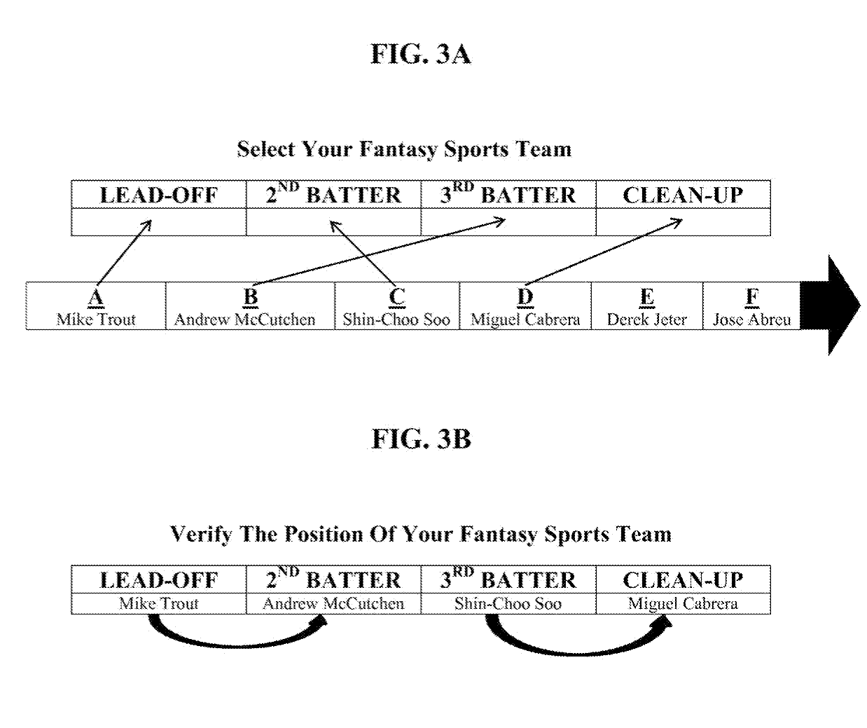

Thus collectively to sum as described hereinabove, in accordance with embodiments of the present invention, a fantasy sports user selects the specific order of players from a pool of plurality of players to bat who have a game coming up in a near term window which is demonstrated in FIG. 3A. Following the selection of the fantasy sports team, the fantasy sports user thereafter verifies the correct order of the selected players who will bat, and as such, the fantasy sports user has the option of changing the selected order of players (FIG. 3A), which is depicted in FIG. 3B until a ticket/lineup is finally released prior to the start of a game, in which the chosen players will bat once on the fantasy sports roster.

In addition, in accordance with the embodiments described above, a prize is further awarded to the fantasy sports user, all depending on the total amount of score that is accrued, wherein the score correlates positively with the amount of a predetermined prize.

In conformance with the above embodiments, the person having ordinary skill in the art will appreciate that additional rules apply, which are summarized herein below as follows.

If a given player hits a single, that player becomes a runner on the first base and also advances all other base runners with one base. If he hits a double and triple, the batter would become a runner on second and third base and would hence advance all other base runners two and three bases respectively. A strikeout results in no base runners that advance and at least a player is lost from the fantasy sports team. A sacrifice fly results in that that all base runners advance one base and at least one player is lost from the fantasy sports team. A hit-by-pitch advances forced runners a base, wherein the forced runners are anybody on the first, second if there is also a runner on the first and anybody on the third base in case there are also runners on the first and second base. Steals result in no further effect, whereas a fielder's choice removes the lead runner wherein at least one player is deemed out. It should be understood that if there are no runners, then the batter is the lead runner. Double play results in the act of at least one player being deemed out if bases are empty, and at least two players are deemed out if there is at least one runner. If bases are loaded, the end result is a runner on second and third base with the end-result of no runner scoring. On the other hand, if runners are only on the first and second base, the end-result is a player on the second base with no runner scoring points. If runners are only located on the first and third base, the end-result is no runners on base with one runner scoring, as runners going to first and second base are deemed out, such that only the runner going home scores. A triple play results in a scenario of at least one player being deemed out if bases are empty, at least two players are deemed out if there is one runner and at least three players are deemed out if there are at least two runners.

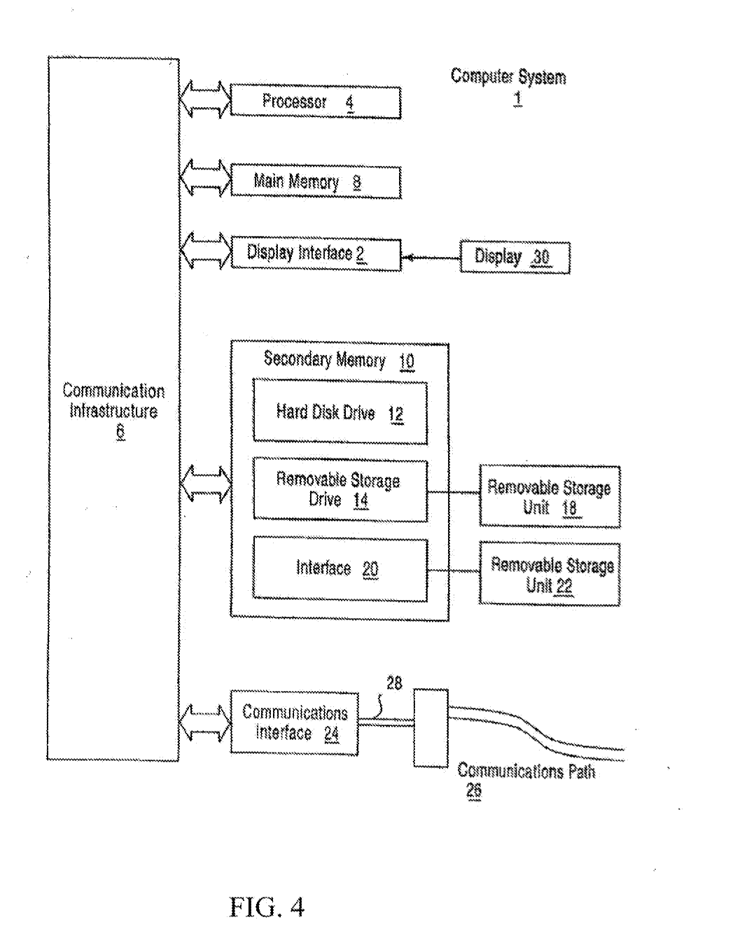

As demonstrated in one embodiment of the present invention in FIG. 4, the instant invention may be implemented using a hardware, software, or any combinations thereof, and may further be implemented in one or more computer systems or other processing systems.

In one embodiment, the invention is directed towards one or more computer systems, which have the capability of carrying out the functionality described herein.

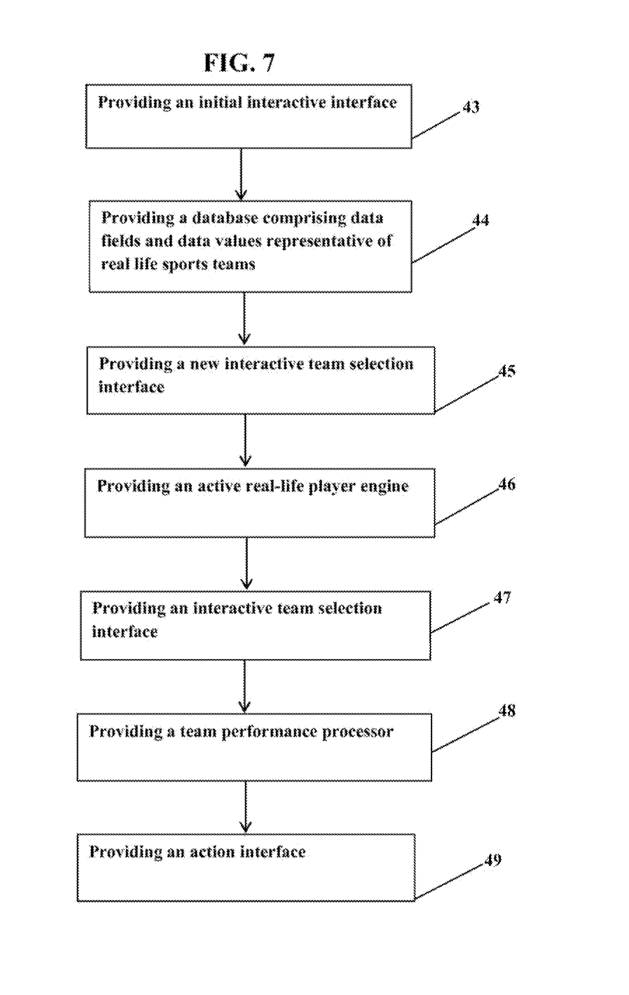

FIG. 4 depicts a computer system 1 that includes one or more processors 4. The processor 4 is connected to a communication infrastructure 6, which can be a communications-bus, cross-over bar or a network. Various software embodiments are described in terms of this exemplary computer-system. After reading this description, it will become readily apparent to a person having skill in the relevant arts how to implement the invention using additional computer systems (FIG. 7).

The computer system 1 can include a display interface 2 that forwards graphics, texts, and other data from the communication infrastructure 6 for display on the display unit 30. In some embodiments, a display interface 2 or a dedicated display interface may be unnecessary. As generally described herein, computer system 1 may also transmit communications over a network to a user device wherein the communications display content and/or GUI for the game system on the display screen of the user device (e.g., in response to receiving the communication). For example, in a browser based system, the communications carry instructions and data for displaying the interface in the browser window of the user.

Computer system 1 also includes a main memory 8, preferably in the form of random access memory (RAM), and may also further include a secondary memory 10. The secondary memory 10 may include for example a hard disk drive 12 and a removable storage drive 14, representing a floppy disk drive, a magnetic tape drive and an optical disk drive. The removable storage drive 14 reads from and writes to a removable storage unit 18 in a well-known manner. Removable storage unit 18 represents a floppy disk, magnetic tape, optical disk, which is read by and written to removable storage drive 14. As will be appreciated by the skilled artisan, the removable storage unit 18 includes a computer usable storage medium having stored therein computer software and/or data.

In alternative embodiments, secondary memory 10 may include other similar devices for allowing computer programs or other instructions to be loaded into computer system 1. Such devices may include for example a removable storage unit 22 and an interface 20. Examples of such may include a program cartridge and cartridge interface (such as that found in video game devices), a removable memory chip (such as an erasable programmable read only memory (EPROM), or programmable read only memory (PROM) and associated socket, and other removable storage units 22 and interfaces 20, which allow software and data to be transferred from the removable storage unit 22 to computer system 1.

Computer system 1 may also include a communications interface 24. Communications interface 24 allows software and data to be transferred between computer system 1 and external devices. Examples of communications interface 24 may include a modem, a network interface such as an Ethernet card, a communications port, a Personal Computer Memory Card International Association (PCMCIA) slot and card. Software and data transferred via communications interface 24 are in the form of signals 28, which may be electronic, electromagnetic, optical or other signals capable of being received by communications interface 24. These signals 28 are provided to communications interface 24 via a communications path (e.g., channel) 26. This path 26 carries signals 28 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 14, a hard disk installed in hard disk drive 12, and signals 28. These computer program products provide software to the computer system 1. The invention is directed to such computer program products.

Computer programs also referred to as computer control logic are stored in main memory 8 and/or secondary memory 10. Computer programs may also be received via communications interface 24. Such computer programs, when executed, enable the computer system 1 to perform the features of the present invention as discussed herein. In particular, the computer programs, when executed, enable the processor 4 to perform the features of the present invention. Accordingly, such computer programs represent controllers of the computer system 1.

In an embodiment in which the invention is implemented using software, the software may be stored in a computer program product and loaded into computer system 1 using removable storage drive 14, hard drive 12, or communications interface 24. The control logic, which is the software when executed by the processor 4 causes the processor 4 to perform the functions of the invention as described herein.

In another embodiment, the invention is implemented primarily in hardware using for example hardware components, such as application specific integrated circuits (ASICs). Implementation of the hardware state machine so as to perform the functions described herein will be apparent to persons skilled in the relevant arts.

In yet another embodiment, the invention is implemented using a combination of both hardware and software.

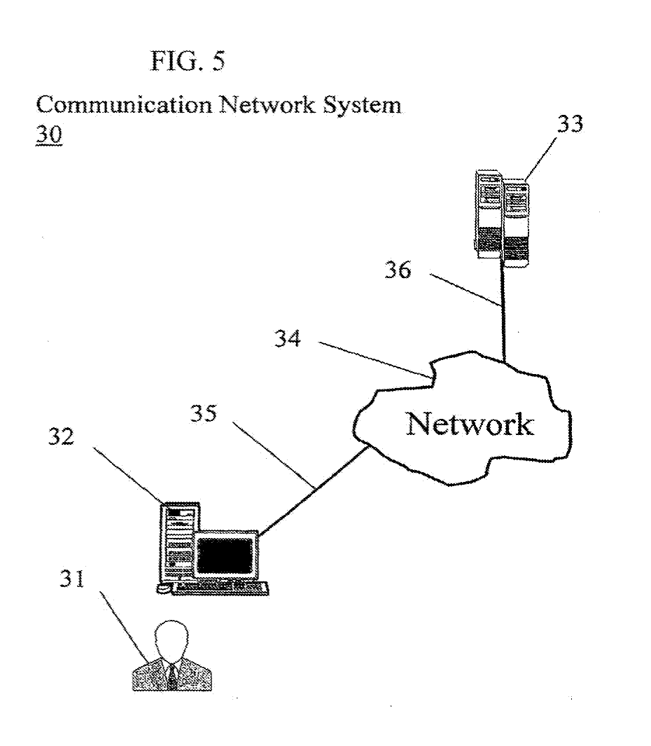

As shown in FIG. 5, the communication system 30 includes an accessor 31, also referred to herein as a “user” and a terminal 32. In one embodiment, the data for use in the computer system 1 is for example input and/or accessed by the accessor 31 via the terminal 32 such as but not limited to a personal computer (PC), minicomputer, mainframe computer, microcomputer, telephonic device, or wireless device, such as a hand-held wireless device coupled to a server 33, such as but not limited to a PC, minicomputer, mainframe computer, microcomputer, or other device having a processor and a repository for data and/or connection to a processor and/or repository for data, via for example a network 34, such as but not limited to the Internet or an Intranet and couplings 35 and 36. The couplings 35 and 36 include for example, wired, wireless, or fiberoptic links.

In another embodiment, the method and system of the present invention may equally well operate in a stand-alone environment such as but not limited to a single terminal. This can for example encompass in various other embodiments a casino-type game, or in mobile app devices.

Thus in these instances, where the game is played as a casino-type game (e.g., video gaming machines) or on mobile app devices, the user would play the game using slot machines and mobile telephones, where the premise would not deviate from playing on a computer system over the Internet. Thus in accordance with the previously described embodiments, the user would similarly pick four players from a pool of a plurality of players having upcoming games, and correspondingly their specific batting order as depicted in FIG. 3A and FIG. 3B.

For all data received or transmitted in the present invention such as player statistics in the form of total runs performed or outs or other fantasy team scores may be calculated based on values input, which may be manually input or downloaded from a database at any location preferably remotely. The database itself can be online stored in a fixed memory or disk-based.

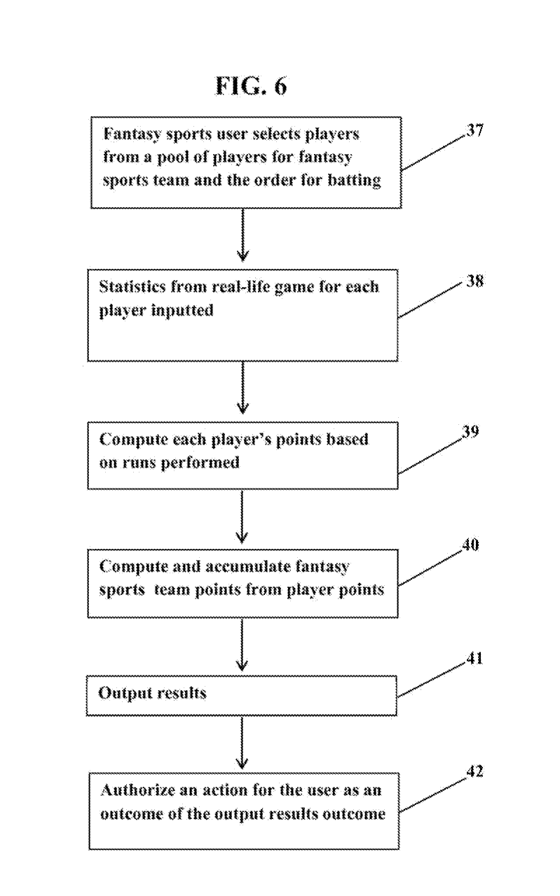

The methods and steps are shown in FIG. 6 for a particular real-sports event such as baseball. As previously described, a fantasy sports user selects four players to bat in a specific order from any MLB team that has a game coming up in a near term window. As demonstrated in FIG. 6, in accordance with an embodiment of the invention, at step 37, a first set of input data is received. Thus, the first set of data input includes the identity of the players, and the specific order in which the players will bat in the fantasy sports lineup. At step 38, a second set of input data is received. The second set of input data includes each player's statistics achieved from the real-life game, wherein the statistics correspond to runs performed by each player. At step 39, each player's points are computed based on each player's aforementioned statistics. At step 40, a total of fantasy sports points are computed and accumulated, and an output of the results are given at step 41. Finally at step 42, an authorization is provided to the user as an outcome of the output results that were determined at step 41.

In order for the skilled artisan to understand and appreciate the present invention, the individual mechanics of how exactly the computer system of the present invention operates in the embodiment described above is more specifically depicted sequentially in detail in FIG. 7.

The computer system comprises an initial interactive interface that displays a selectable option to enter a fantasy sports game as demonstrated at step 43.

A database is then provided at step 44 comprising data fields and data values representing real life sports teams, real life upcoming schedule of the real life teams, real life players that are presently on the active rosters of the real life sports teams, status of real life players in connection with the upcoming games, and data representing statistical performance of the real life players in regularly scheduled games of the real life sports teams.

In the computer system at step 45, an interactive new team interface is implemented by the computer system, where the individual fantasy sports users of the game system are provided with a team selection option, that when so selected, provides the opportunity to make selections to complete a team submission.

At step 46, an active real life player engine is provided that receives an input from the individual fantasy sports user, indicating that the user has selected to submit a fantasy sports team into computer system and also receives information about the current time. In response to receiving the player selection input, the data stored is processed in the database predetermined near term time window, and the data is thereafter applied in the near term time window to the data values in the database, where the computer system generates an output identifying the identity of real life players in the database, that are scheduled to play during the upcoming near term time window. Moreover, the computer system subsequently identifies which real life games that the identified players are scheduled to play in. Additionally the computer system only identifies a subset of real life players from all players that play in a corresponding real life league or sport, such that a season is divided into scheduled games that have much smaller time windows comprising multiple upcoming games or portions of games but less than a full or remaining season.

At step 47, an interactive team selection interface receives the output from the active real life player engine, and retrieves and displays data from the database associated with a plurality of the identified real life players.

In addition, at step 47, the computer system specifies a number of team player slots that form a team submission for the fantasy sports game of the user. The computer system receives and stores input selections in response to the user selecting different players of the real life sports events identified by the active real life player engine. As previously described, the fantasy sports user selects a specific sequence, in which the selected real life players are placed in a sequential performance lineup on the individual user's fantasy sports team as part of the individual user's fantasy team in the fantasy sports game, where the sequence is asynchronous in comparison to an actual time sequence, in which the selected real life players play in their corresponding real life games. A game data input port receives and stores performance statistical data values generated from the actual play of real life players, which is representative of real life athletic achievement of the real life players in the real life scheduled games.

At step 48, a team performance processor receives team information identifying the real life players selected by the fantasy sports user, and further receives performance statistical data values from the game data input port. The performance processor then associates the performance statistical data values with the real life players on the user created team, and thereafter compares individual performance values between each real life player on the user created fantasy sports team and a subsequent one of the individual life players on the user created fantasy sports team in accordance with the user-selected sequence. Based on this comparison, the performance processor determines whether one or more in-fantasy sports game performance inter-relationships between the individual performance values of the real life players of the user created team based on the player performance lineup sequence of play selected by the user qualifies to meet at least one in-game team performance advancement characteristic.

At step 48, the performance processor then generates an in-game or final fantasy sports score for the user-created fantasy sports team by modifying the performance value of the real life players on the user created team with an in-fantasy sports game performance inter-relationship value associated with the at least one in-game team performance advancement characteristic to produce a score value, that incorporates an enhanced performance relationship arising from the one or more in-fantasy sports game performance inter-relationships. The score value is then stored and transmitted to the user.

Finally at step 49, an action interface then applies the score value to outcome criteria and based on the application, the action interface generates an outcome output value indicative of, whether the user has qualified to be a recipient of a particular operation by the game system which concludes the string of operations executed by the computer system.

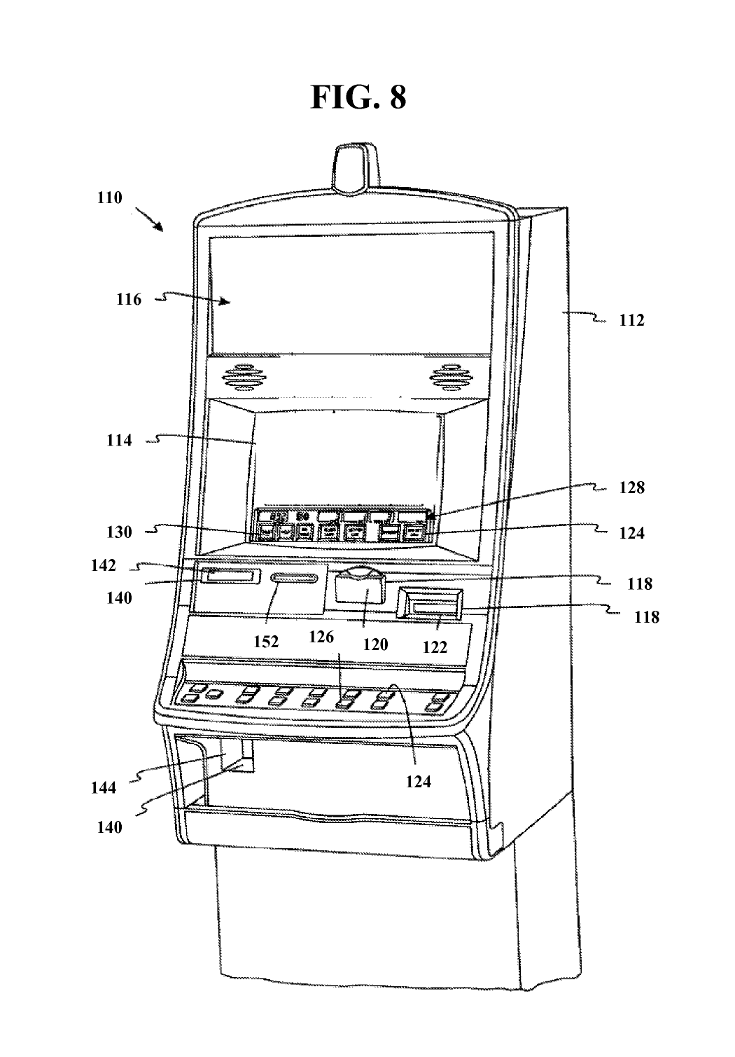

Referring to FIG. 8, a gaming machine 110 is used in gaming establishments such as casinos. The gaming machine 110 may be any type of gaming machine and may have varying structures and methods of operation. For example, the gaming machine 110 may be an electromechanical gaming machine configured to play mechanical slots, or it may be an electronic gaming machine configured to play a video casino game, such as slots, keno, poker, blackjack, roulette, etc. The gaming machine 110, in some examples, may also be referred to as a video gaming machine, a casino gaming machine, a gaming terminal, or a wagering game machine.

The gaming machine 110 comprises a housing 112 and includes input devices, including a value input device 118 and a player input device 124. For output, the gaming machine 110 includes a primary display 114 for displaying information about the basic wagering game. The primary display 114 can also display information about a bonus wagering game and a progressive wagering game. The gaming machine 110 may also include a secondary display 116 for displaying game events, game outcomes, and/or signage information. While these typical components found in the gaming machine 110 are described below, it should be understood that numerous other elements may exist and may be used in any number of combinations to create various forms of a gaming machine 110.

The value input device 118 may be provided in many forms, individually or in combination, and is preferably located on the front of the housing 112. The value input device 118 receives currency and/or credits that are inserted by a player. The value input device 118 may include a coin acceptor 120 for receiving coin currency. Alternatively, or in addition, the value input device 118 may include a bill acceptor 122 for receiving paper currency. Furthermore, the value input device 118 may include a ticket reader, or barcode scanner, for reading information stored on a credit ticket, a card, or other tangible portable credit storage device. The credit ticket or card may also authorize access to a central account, which can transfer money to the gaming machine 110.

The player input device 124 comprises a plurality of push buttons 126 on a button panel for operating the gaming machine 110. In addition, or alternatively, the player input device 124 may comprise a touch screen 128 mounted by adhesive, tape, or the like over the primary display 114 and/or secondary display 116. The touch screen 128 contains soft touch keys 130 denoted by graphics on the underlying primary display 114 and used to operate the gaming machine 110. The touch screen 128 provides players with an alternative method of input. A player enables a desired function either by touching the touch screen 128 at an appropriate touch key 130 or by pressing an appropriate push button 126 on the button panel. The touch keys 130 may be used to implement the same functions as push buttons 126. Alternatively, the push buttons 126 may provide inputs for one aspect of the operating the game, while the touch keys 130 may allow for input needed for another aspect of the game.

The various components of the gaming machine 110 may be connected directly to, or contained within, the housing 112, as seen in FIG. 8, or may be located outboard of the housing 112 and connected to the housing 112 via a variety of different wired or wireless connection methods. Thus, the gaming machine 110 comprises these components whether housed in the housing 112, or outboard of the housing 112 and connected remotely.

The operation of the basic wagering game is displayed to the player on the primary display 114. The primary display 114 can also display the bonus game associated with the basic wagering game. The primary display 114 may take the form of a cathode ray tube (CRT), a high resolution LCD, a plasma display, an LED, or any other type of display suitable for use in the gaming machine 110. As shown, the primary display 114 includes the touch screen 128 overlaying the entire display (or a portion thereof) to allow players to make game-related selections. In the illustrated embodiment, the gaming machine 110 is an “upright” version in which the primary display 114 is oriented vertically relative to the player. Alternatively, the gaming machine may be a “slant-top” version in which the primary display 114 is slanted at about a thirty-degree angle toward the player of the gaming machine 110.

A player begins play of the basic wagering game by making a wager via the value input device 118 of the gaming machine 110. A player can select play by using the player input device 124, via the buttons 126 or the touch screen keys 130.

In some embodiments, the gaming machine 110 may also include a player information reader 152 that allows for identification of a player by reading a card with information indicating his or her true identity. The player information reader 152 is shown in FIG. 8 as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 152, which allows the casino's computers to register that player's wagering at the gaming machine 110. The gaming machine 110 may use the secondary display 116 or other dedicated player-tracking display for providing the player with information about his or her account or other player-specific information. Also, in some embodiments, the information reader 152 may be used to restore game assets that the player achieved and saved during a previous game session.

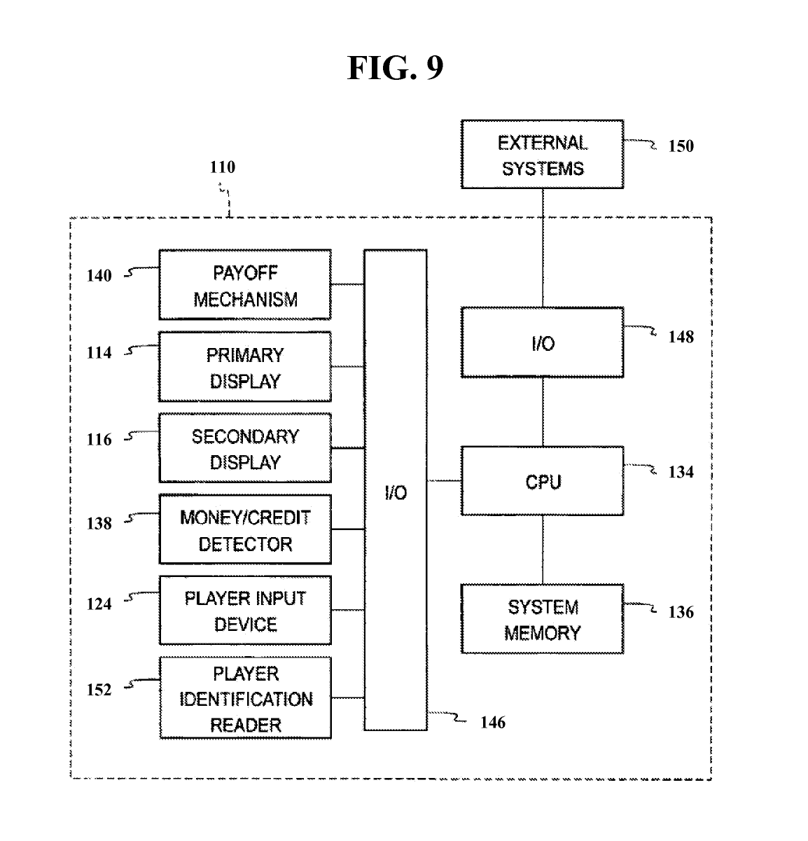

Turning now to FIG. 9, the various components of the gaming machine 110 are controlled by a central processing unit (CPU) 134, also referred to herein as a controller or processor (such as a microcontroller or microprocessor). To provide gaming functions, the controller 134 executes one or more game programs stored in a computer readable storage medium, in the form of memory 136. It should be appreciated that the controller 134 may include one or more microprocessors, including but not limited to a master processor, a slave processor, and a secondary or parallel processor.

The controller 134 is also coupled to the system memory 136 and a money/credit detector 138. The system memory 136 may comprise a volatile memory (e.g., a random-access memory (RAM)) and a non-volatile memory (e.g., an EEPROM). The system memory 136 may include multiple RAM and multiple program memories. The money/credit detector 138 signals the processor that money and/or credits have been input via the value input device 118. Preferably, these components are located within the housing 112 of the gaming machine 110. However, as explained above, these components may be located outboard of the housing 112 and connected to the remainder of the components of the gaming machine 110 via a variety of different wired or wireless connection methods.

As seen in FIG. 9, the controller 134 is also connected to, and controls, the primary display 114, the player input device 124, and a payoff mechanism 140. The payoff mechanism 140 is operable in response to instructions from the controller 134 to award a payoff to the player in response to certain winning outcomes that might occur in the game. The payoff may be provided in the form of points, bills, tickets, coupons, cards, etc. For example, in FIG. 8, the payoff mechanism 140 includes both a ticket printer 142 and a coin outlet 144. However, any of a variety of payoff mechanisms 140 well known in the art may be implemented, including cards, coins, tickets, smartcards, cash, etc. The payoff amounts distributed by the payoff mechanism 140 are determined by one or more pay tables stored in the system memory 136.

Communications between the controller 134 and both the peripheral components of the gaming machine 110 and external systems 150 occur through input/output (1/O) circuits 146, 148. More specifically, the controller 134 controls and receives inputs from the peripheral components of the gaming machine 110 through the input/output circuits 146. Further, the controller 134 communicates with the external systems 150 via the I/O circuits 148 and a communication path (e.g., serial, parallel, IR, RC, 10bT, etc.). The external systems 150 may include a gaming network, other gaming machines, a gaming server, communications hardware, or a variety of other interfaced systems or components. Although the I/O circuits 146, 148 may be shown as a single block, it should be appreciated that each of the I/O circuits 146, 148 may include a number of different types of I/O circuits.

Controller 134, as used herein, comprises any combination of hardware, software, and/or firmware that may be disposed or resident inside and/or outside of the gaming machine 110 that may communicate with and/or control the transfer of data between the gaming machine 110 and a bus, another computer, processor, or device and/or a service and/or a network. The controller 134 may comprise one or more controllers or processors. In FIG. 9, the controller 134 in the gaming machine 110 is depicted as comprising a CPU, but the controller 134 may alternatively comprise a CPU in combination with other components, such as the I/O circuits 146, 148 and the system memory 136. The controller 134 may reside partially or entirely inside or outside of the machine 110.

The gaming machines 110 may communicate with external systems 150 (in a wired or wireless manner) such that each machine operates as a “thin client,” having relatively less functionality, a “thick client,” having relatively more functionality, or through any range of functionality therebetween (e.g., a “rich client”). As a generally “thin client,” the gaming machine may operate primarily as a display device to display the results of gaming outcomes processed externally, for example, on a server as part of the external systems 150. In this “thin client” configuration, the server executes game code and determines game outcomes (e.g., with a random number generator), while the controller 134 on board the gaming machine processes display information to be displayed on the display(s) of the machine. In an alternative “rich client” configuration, the server determines game outcomes, while the controller 134 on board the gaming machine executes game code and processes display information to be displayed on the display(s) of the machines. In yet another alternative “thick client” configuration, the controller 134 on board the gaming machine 110 executes game code, determines game outcomes, and processes display information to be displayed on the display(s) of the machine. Numerous alternative configurations are possible such that the aforementioned and other functions may be performed onboard or external to the gaming machine as may be necessary for particular applications. It should be understood that the gaming machines 110 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

The fantasy game of the present invention may be implemented on the above gaming machine 110 (e.g., a gaming machine to be played in a casino or other gaming establishment or even in a remote location). The fantasy game may also be played via an electronic communications network, e.g., Internet.

The features of embodiments of the game system are particularly applicable to baseball but are not limited to baseball games. Also, the team selection mechanism is not limited to just being 4 players although 4 might be particularly suitable for quicker games.

A video gaming machine and/or system provides unique benefits such as providing a new type of gaming terminal for casino customer involving a sports game with which people are generally familiar with. The sports betting area of casinos can also benefit because of new type of gaming machine that can enhance their business by providing for additional customers to visit and stay in the area.

Another unique advantage that can be provided has to with the ability to provide the excitement of a live game. In such a configuration, the near term window narrows the available players to those that will be at bat in minutes (e.g., in the next few minutes such then next 1-2 or 0-5, 0-10, or 0-30 minutes). This allows the user to experience a quick live game from an individual at performance of players. The systems or gaming machine can allow the user to start multiple games in parallel (e.g., 1-10) games so that they can have multiple active game in the near term window.

In sum, it is to be understood that the present invention is not solely limited to real-time sports events such as but not limited to baseball and cricket, but it can equally be applicable to any other sports events that are deemed readily apparent and obvious to the skilled artisan to which this invention belongs, and all equivalent relationships to those illustrated in the drawings and described in the specification are intended to be encompassed by the present invention.

Thus the foregoing is solely considered as illustrative only of the principles of the invention.

Technical advantages and efficiencies from systems and processes described herein would be readily understood by those of ordinary skill in the art. Some examples of technical aspects and advantages follow. The system limits a stream of data available to the current user by limiting the available stream to data that is within a near term window. The system controls the available players for selection for the user's team before the fantasy game starts to those that are in the roster and batting lineup in the near term window (in the next hour or two-three hours). The system applies and converts synchronous data to be asynchronous. The system implements synchronous data to have an asynchronous meaning or value in another game or system. For example, data communicating the sequence information received communicating each battering performance of a real life player at bat (in the near time window) is converted to be asynchronous in that the data from the at performance is implemented and applies in a sequence selected by the user (selected lineup of the user) and the conversion generates different results based on interrelationship of performance between at bat results. The system identifies inter-relationships between unrelated event data (performance results for different individuals at bat at in different games) and determines the value of interrelationships within an overall near time window. It also determines values of inter-relationships in performance based on a user-selected asynchronous sequence of events.

It is would be understood to those of ordinary skill in the art that the embodiments of the invention contemplate different combinations, different sequences, removal (or broadening), and addition (from other parts of the description or embodiments) of features, elements, steps, or processes. For example, inventions understood from the embodiments are also contemplated to include broader inventions that may not contain described features of an embodiment or may combine features from different embodiments as would be understood.

It would also be understood that descriptions of embodiments would be understood to be encompass systems, methods, and computer readable medium. For example, a description of a process would be understood to also describe a system and features for a system.

Further since numerous modifications and changes will readily be apparent to those having ordinary skill in the art, it is not desired to limit the invention to the exact constructions as demonstrated in this disclosure. Accordingly all suitable modifications and equivalents may be resorted to falling within the scope of the invention. Unless defined otherwise, all technical and scientific terms used herein have same meaning as commonly understood by the person of ordinary skill in the art to which this invention belongs. As used herein and in the appended claims, the singular form “a”, “and”, and “the” include plural referents unless the context clearly dictates otherwise. All technical and scientific terms used herein have the same meaning. Thus the scope of the embodiments of the present invention should be determined by the appended claims and their legal equivalents rather than by the Figures.

What is claimed is:

1. A game system comprising:
a gaming machine and an external device comprising transient and non-transient memory and including network connections and equipment, that are together configured to provide features comprising:
an initial interactive interface that displays a selectable option to enter a fantasy sports game,
a database comprising data fields and data values representative of real life sports teams, real life upcoming schedule of the real life teams, real life players that are currently on the active rosters of the real life sports teams, status of real life players in connection with the upcoming games, and data representing statistical performance of the real life players in regularly scheduled games of the real life sports teams,
an interactive new team interface implemented by the computer system in which individual users of the game system are provided with a team creation option that when selected provides the opportunity to make selections to complete a team submission;
an active real life player engine that:
receives an input from an individual user indicating that the user has selected to submit a fantasy sports team into system and also receives information about the current time,
in response to receiving the input, processing the data stored in the database and a predetermined near term time window and applying the near term time window to the data values in the database wherein the computer system generates an output identifying which real life players in the database are scheduled to play during the upcoming near term time window and identifies which real life games the identified players are scheduled to play in, and further wherein the computer system only identifies a subset of real life players from players that play in a corresponding real life league or sport so as to divide a season of scheduled games into smaller time windows comprising multiple upcoming games or portions of games but less than a full or remaining season, an interactive team selection interface that:
receives the output from the active real life player engine, and retrieves and displays data from the database associated with a plurality of the identified real life players,
specifies a number of team player slots that form a team submission for the fantasy sports game of the user,
receives and stores input selections in response to the user selecting different ones of the real life players identified by the active real life player engine and the user also selecting a particular sequence in which the selected real life players are placed in a sequential performance lineup on the individual user's fantasy sports team as part of the individual user's fantasy team in the fantasy sports game, wherein the sequence is asynchronous in comparison to an actual time sequence in which the selected real life players play in their corresponding real life games,
game data input port that receives and stores performance statistical data values generated from the actual play of real life player and representative of real life athletic achievement of real life players in the real life scheduled games,
a team performance processor that
receives team information identifying the real life players selected by the individual user to be on the user's team,
receives performance statistical data values from the game data input port,
associates the performance statistical data values with the real life players on the user created team,
compares individual performance values between each real life player on the user created fantasy sports team and a subsequent one of the individual life players on the user created fantasy sports team in accordance with the user-selected sequence,
based on the comparing, determining whether one or more in-fantasy sports game performance inter-relationships between the individual performance values of the real life players of the user created team based on the player performance lineup sequence of play selected by the user qualifies to meet at least one in-game team performance advancement characteristic,
generates an in-game or final fantasy sports score for the user-created fantasy sports team by modifying the performance value of the real life players on the user created team with an in-fantasy sports game performance inter-relationship value associated with the at least one in-game team performance advancement characteristic to produce a score value that incorporates an enhanced performance relationship arising from the one or more in-fantasy sports game performance inter-relationships, and
stores and transmits the score value as part of displaying the score value to the user,
an action interface that applies the score value to outcome criteria and based on the applying generates an outcome output value indicative of whether the user has qualified to be a recipient of a particular operation by the game system.

2. The game system of claim 1 wherein the game system is a fantasy baseball game system wherein the system is configured to determine whether one or more in-fantasy sports game performance inter-relationships comprises a first performance value for a first real life fantasy player on the user created fantasy team has a characteristic sufficient to advance a second performance value for a second real life player on the user created fantasy team, wherein the second real life player precedes the first real life fantasy player on the user selected lineup sequence.

3. The game system of claim 1 wherein the game system comprises a fantasy point system that associates a particular fantasy point with different performance statistic values is a fantasy football game system wherein the system is configured to determine whether one or more in-fantasy sports game performance inter-relationships comprises a first real life player and second real life player that are designated for different downs on the user created fantasy sports team together have sufficient yards to have a first down.

4. The game system of claim 1 wherein the game system comprises a fantasy point system implemented as part of the computer that system that assigns fantasy points to different events or performance values in the real life sport.

5. The game system of claim 1 wherein the game system identifies real life players for selections as party of a team submission using only a portion of upcoming games.
